(19) United States
(12) Patent Application Publication
(10) Pub. No.: US 2019/0279250 A1
(43) Pub. Date: Sep. 12, 2019

(54) AUDIO CONTENT ENGINE FOR AUDIO AUGMENTED REALITY

(71) Applicant: Bose Corporation, Framingham, MA (US)

(72) Inventors: John Gordon, Lexington, MA (US); Glenn Gomes-Casseres, Framingham, MA (US); Fuat Koro, Lincoln, MA (US); Santiago Carvajal, West Newton, MA (US)

(21) Appl. No.: 16/297,466

(22) Filed: Mar. 8, 2019

Related U.S. Application Data
(60) Provisional application No. 62/640,372, filed on Mar. 8, 2018.

(51) Int. Cl. G06Q 30/02; G06F 16/687; G06F 3/01; G06F 16/635; H04R 5/04

(52) U.S. Cl. CPC G06Q 30/0261; G06F 16/687; H04R 5/04; G06F 16/635; G06F 3/017

(57) ABSTRACT

Various implementations include wearable audio devices and related methods for controlling such devices. In some particular implementations, a computer-implemented method of controlling a wearable audio device configured to provide an audio output includes: receiving data indicating the wearable audio device is proximate a geographic location associated with a localized audio message; inserting audio content associated with a brand into an identified portion of the localized audio message; and initiating playback of the localized audio message including the inserted audio content associated with the brand at the wearable audio device.

### CROSS-REFERENCE TO RELATED APPLICATIONS

This application claims the benefit of U.S. Application No. 62/640,372, filed on Mar. 8, 2018, the disclosure of which is incorporated by reference in its entirety.

### TECHNICAL FIELD

This disclosure generally relates to audio devices. More particularly, the disclosure relates to audio devices, such as wearable audio devices, including a location based audio module for providing location-specific audio to the user at the wearable audio device.

### BACKGROUND

Portable electronic devices, including headphones and other wearable audio systems are becoming more commonplace. However, the user experience with these audio systems is limited by the inability of these systems to adapt to different environments and locations.

### SUMMARY

In general, one innovative aspect of the subject matter described in this specification can be embodied in a software engine that controls the inserting of audio content (e.g., audio notifications, alerts, audio advertisements, etc.) into an audio message for delivery to a wearable audio device for playing to a wearer of the device.

In some particular aspects, a computer-implemented method of controlling a wearable audio device configured to provide an audio output includes: receiving data indicating the wearable audio device is proximate a geographic location associated with a localized audio message; inserting audio content associated with a brand into an identified portion of the localized audio message; and initiating playback of the localized audio message including the inserted audio content associated with the brand at the wearable audio device.

Implementations may include one of the following features, or any combination thereof.

In particular cases, the inserted audio content associated with the brand may be selected based upon a user of the wearable audio device. The inserted audio content associated with the brand may be selected based upon a predefined preference of the user of the wearable audio device. The inserted audio content associated with the brand may be selected based upon a facing direction of the user of the wearable audio device. The method may further include receiving data indicating feedback from the user in response to the playback of the localized audio message. The feedback data may represent a gesture from the user. The feedback data may represent an interaction of the user and a smart device. The method may further include initiating the presentation of additional information to the user in response to the received feedback data. The additional information may include additional audio content associated with the brand. The additional information may include imagery associated with the brand for presenting by a smart device.

In other particular aspects, a computing device includes: memory; and one or more processing devices configured to: receive data indicating the wearable audio device is proximate a geographic location associated with a localized audio message; insert audio content associated with a brand into an identified portion of the localized audio message; and initiate playback of the localized audio message including the inserted audio content associated with the brand at the wearable audio device.

Implementations may include one of the following features, or any combination thereof.

In particular cases, the inserted audio content associated with the brand may be selected based upon a user of the wearable audio device. The inserted audio content associated with the brand may be selected based upon a predefined preference of the user of the wearable audio device. The inserted audio content associated with the brand may be selected based upon a facing direction of the user of the wearable audio device. The one or more processing devices may be further configured to receive data indicating feedback from the user in response to the playback of the localized audio message. The feedback data may represent a gesture from the user. The feedback data may represent an interaction of the user and a smart device. The one or more processing devices may be further configured to initiate the presentation of additional information to the user in response to the received feedback data. The additional information may include additional audio content associated with the brand. The additional information may include imagery associated with the brand for presenting by a smart device.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

Two or more features described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

FIG. 1 is a block diagram depicting an example personal audio device according to various disclosed implementations.

FIG. 2 shows a schematic data flow diagram illustrating control processes performed by a location-based audio engine in the personal audio device of FIG. 1.

FIG. 3 illustrates an example of a portion of an SDK to enable augmented reality audio.

FIG. 4 illustrates a user selecting a language channel for an audio guided tour.

FIG. 5 continues the example of the augmented reality audio guided tour.

FIG. 6 is a cloud-based environment that includes an engine for selecting and providing asset content.

FIG. 7 is a flowchart of operations of a font presenter executed by a cloud-based engine.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that an audio control system can be beneficially incorporated into a wearable audio device to provide for added functionality. For example, an audio control system can help to enable, among other things, location-based audio playback providing the user with an immersive, dynamic travel experience.

Commonly labeled components in the FIGURES are considered to be substantially equivalent components for the purposes of illustration, and redundant discussion of those components is omitted for clarity.

It has become commonplace for those who either listen to electronically provided audio (e.g., audio from an audio source such as a mobile phone, tablet, computer, CD player, radio or MP3 player), those who simply seek to be acoustically isolated from unwanted or possibly harmful sounds in a given environment, and those engaging in two-way communications to employ personal audio devices to perform these functions. For those who employ headphones or headset forms of personal audio devices to listen to electronically provided audio, it is commonplace for that audio to be provided with at least two audio channels (e.g., stereo audio with left and right channels) to be separately acoustically output with separate earpieces to each ear. For those simply seeking to be acoustically isolated from unwanted or possibly harmful sounds, it has become commonplace for acoustic isolation to be achieved through the use of active noise reduction (ANR) techniques based on the acoustic output of anti-noise sounds in addition to passive noise reduction (PNR) techniques based on sound absorbing and/or reflecting materials. Further, it is commonplace to combine ANR with other audio functions in headphones.

Aspects and implementations disclosed herein may be applicable to a wide variety of personal audio devices, such as a portable speaker, headphones, and wearable audio devices in various form factors, such as watches, glasses, neck-worn speakers, shoulder-worn speakers, body-worn speakers, etc. Unless specified otherwise, the term headphone, as used in this document, includes various types of personal audio devices such as around-the-ear, over-the-ear and in-ear headsets, earphones, earbuds, hearing aids, or other wireless-enabled audio devices structured to be positioned near, around or within one or both ears of a user. Unless specified otherwise, the term wearable audio device, as used in this document, includes headphones and various other types of personal audio devices such as shoulder or body-worn acoustic devices that include one or more acoustic drivers to produce sound without contacting the ears of a user. It should be noted that although specific implementations of personal audio devices primarily serving the purpose of acoustically outputting audio are presented with some degree of detail, such presentations of specific implementations are intended to facilitate understanding through provision of examples, and should not be taken as limiting either the scope of disclosure or the scope of claim coverage.

Aspects and implementations disclosed herein may be applicable to personal audio devices that either do or do not support two-way communications, and either do or do not support active noise reduction (ANR). For personal audio devices that do support either two-way communications or ANR, it is intended that what is disclosed and claimed herein is applicable to a personal audio device incorporating one or more microphones disposed on a portion of the personal audio device that remains outside an ear when in use (e.g., feedforward microphones), on a portion that is inserted into a portion of an ear when in use (e.g., feedback microphones), or disposed on both of such portions. Still other implementations of personal audio devices to which what is disclosed and what is claimed herein is applicable will be apparent to those skilled in the art.

Augmented reality (AR) is a direct or indirect live experience of a physical environment whose elements are “augmented” by computer-generated perceptual information. Typically, augmented reality has been achieved by superimposing, for example, a computer generated image over a live image of a real world location filtered through a computing device such as a camera on a smart phone, smart glasses, etc.

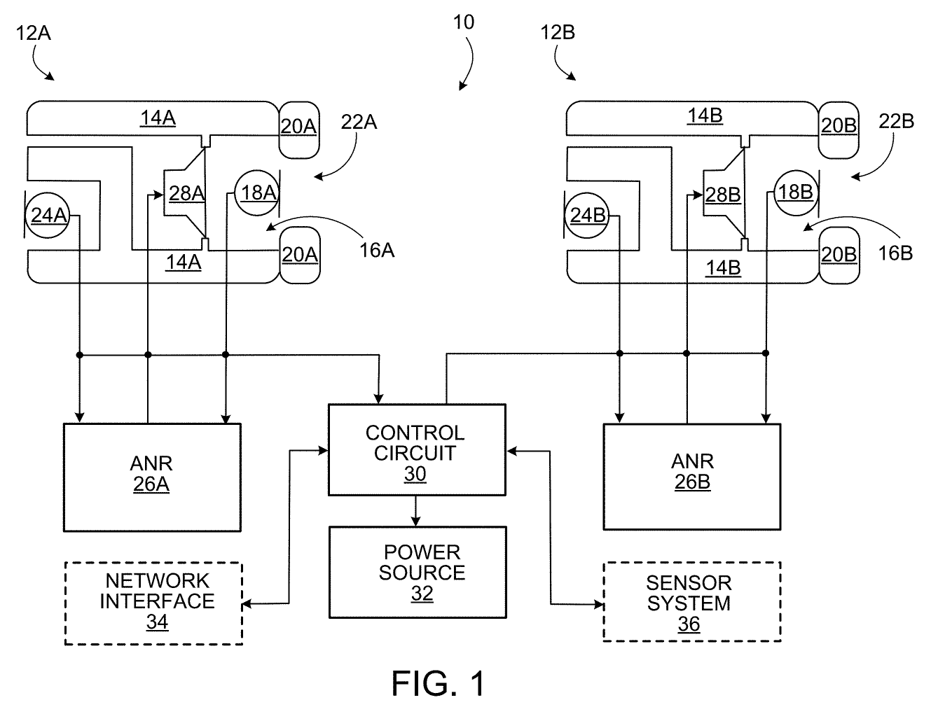

FIG. 1 is a block diagram of an example of a personal audio device 10 having two earpieces 12A and 12B, each configured to direct sound towards an ear of a user. Reference numbers appended with an “A” or a “B” indicate a correspondence of the identified feature with a particular one of the earpieces 12 (e.g., a left earpiece 12A and a right earpiece 12B). Each earpiece 12 includes a casing 14 that defines a cavity 16. In some examples, one or more internal microphones (inner microphone) 18 may be disposed within cavity 16. An ear coupling 20 (e.g., an ear tip or ear cushion) attached to the casing 14 surrounds an opening to the cavity 16. A passage 22 is formed through the ear coupling 20 and communicates with the opening to the cavity 16. In some examples, an outer microphone 24 is disposed on the casing in a manner that permits acoustic coupling to the environment external to the casing.

In implementations that include ANR, the inner microphone 18 may be a feedback microphone and the outer microphone 24 may be a feedforward microphone. In such implementations, each earphone 12 includes an ANR circuit 26 that is in communication with the inner and outer microphones 18 and 24. The ANR circuit 26 receives an inner signal generated by the inner microphone 18 and an outer signal generated by the outer microphone 24, and performs an ANR process for the corresponding earpiece 12. The process includes providing a signal to an electroacoustic transducer (e.g., speaker) 28 disposed in the cavity 16 to generate an anti-noise acoustic signal that reduces or substantially prevents sound from one or more acoustic noise sources that are external to the earphone 12 from being heard by the user. As described herein, in addition to providing an anti-noise acoustic signal, electroacoustic transducer 28 can utilize its sound-radiating surface for providing an audio output for playback, e.g., for a continuous audio feed.

A control circuit 30 is in communication with the inner microphones 18, outer microphones 24, and electroacoustic transducers 28, and receives the inner and/or outer microphone signals. In certain examples, the control circuit 30 includes a microcontroller or processor having a digital signal processor (DSP) and the inner signals from the two inner microphones 18 and/or the outer signals from the two outer microphones 24 are converted to digital format by analog to digital converters. In response to the received inner and/or outer microphone signals, the control circuit 30 can take various actions. For example, audio playback may be initiated, paused or resumed, a notification to a wearer may be provided or altered, and a device in communication with the personal audio device may be controlled. The personal audio device 10 also includes a power source 32. The control circuit 30 and power source 32 may be in one or both of the earpieces 12 or may be in a separate housing in communication with the earpieces 12. The personal audio device 10 may also include a network interface 34 to provide communication between the personal audio device 10 and one or more audio sources and other personal audio devices. The network interface 34 may be wired (e.g., Ethernet) or wireless (e.g., employ a wireless communication protocol such as IEEE 802.11, Bluetooth, Bluetooth Low Energy, or other local area network (LAN) or personal area network (PAN) protocols).

Network interface 34 is shown in phantom, as portions of the interface 34 may be located remotely from personal audio device 10. The network interface 34 can provide for communication between the personal audio device 10, audio sources and/or other networked (e.g., wireless) speaker packages and/or other audio playback devices via one or more communications protocols. The network interface 34 may provide either or both of a wireless interface and a wired interface. The wireless interface can allow the personal audio device 10 to communicate wirelessly with other devices in accordance with any communication protocol noted herein. In some particular cases, a wired interface can be used to provide network interface functions via a wired (e.g., Ethernet) connection.

In some cases, the network interface 34 may also include a network media processor for supporting, e.g., Apple AirPlay® (a proprietary protocol stack/suite developed by Apple Inc., with headquarters in Cupertino, Calif., that allows wireless streaming of audio, video, and photos, together with related metadata between devices) or other known wireless streaming services (e.g., an Internet music service such as: Pandora®, a radio station provided by Pandora Media, Inc. of Oakland, Calif., USA; Spotify®, provided by Spotify USA, Inc., of New York, N.Y., USA); or vTuner®, provided by vTuner.com of New York, N.Y., USA); and network-attached storage (NAS) devices). For example, if a user connects an AirPlay® enabled device, such as an iPhone or iPad device, to the network, the user can then stream music to the network connected audio playback devices via Apple AirPlay®. Notably, the audio playback device can support audio-streaming via AirPlay® and/or DLNA's UPnP protocols, and all integrated within one device. Other digital audio coming from network packets may come straight from the network media processor through (e.g., through a USB bridge) to the control circuit 30. As noted herein, in some cases, control circuit 30 can include a processor and/or microcontroller, which can include decoders, DSP hardware/software, etc. for playing back (rendering) audio content at electroacoustic transducers 28. In some cases, network interface 34 can also include Bluetooth circuitry for Bluetooth applications (e.g., for wireless communication with a Bluetooth enabled audio source such as a smartphone or tablet). In operation, streamed data can pass from the network interface 34 to the control circuit 30, including the processor or microcontroller. The control circuit 30 can execute instructions (e.g., for performing, among other things, digital signal processing, decoding, and equalization functions), including instructions stored in a corresponding memory (which may be internal to control circuit 30 or accessible via network interface 34 or other network connection (e.g., cloud-based connection). The control circuit 30 may be implemented as a chipset of chips that include separate and multiple analog and digital processors. The control circuit 30 may provide, for example, for coordination of other components of the personal audio device 10, such as control of user interfaces (not shown) and applications run by the personal audio device 10.

In addition to a processor and/or microcontroller, control circuit 30 can also include one or more digital-to-analog (D/A) converters for converting the digital audio signal to an analog audio signal. This audio hardware can also include one or more amplifiers which provide amplified analog audio signals to the electroacoustic transducer(s) 28, which each include a sound-radiating surface for providing an audio output for playback. In addition, the audio hardware may include circuitry for processing analog input signals to provide digital audio signals for sharing with other devices.

The memory in control circuit 30 can include, for example, flash memory and/or non-volatile random access memory (NVRAM). In some implementations, instructions (e.g., software) are stored in an information carrier. The instructions, when executed by one or more processing devices (e.g., the processor or microcontroller in control circuit 30), perform one or more processes, such as those described elsewhere herein. The instructions can also be stored by one or more storage devices, such as one or more (e.g. non-transitory) computer-or machine-readable mediums (for example, the memory, or memory on the processor/microcontroller). As described herein, the control circuit 30 (e.g., memory, or memory on the processor/microcontroller) can include a control system including instructions for controlling location-based audio functions according to various particular implementations. It is understood that portions of the control system (e.g., instructions) could also be stored in a remote location or in a distributed location, and could be fetched or otherwise obtained by the control circuit 30 (e.g., via any communications protocol described herein) for execution. The instructions may include instructions for controlling location-based audio processes (i.e., the software modules include logic for processing inputs from a user and/or sensor system to manage audio streams), as well as digital signal processing and equalization. Additional details may be found in U.S. Patent Application Publication 20140277644, U.S. Patent Application Publication 20170098466, and U.S. Patent Application Publication 20140277639, the disclosures of which are incorporated herein by reference in their entirety.

Personal audio device 10 can also include a sensor system 36 coupled with control circuit 30 for detecting one or more conditions of the environment proximate personal audio device 10. Sensor system 36 can include one or more local sensors (e.g., inner microphones 18 and/or outer microphones 24) and/or remote or otherwise wirelessly (or hard-wired) sensors for detecting conditions of the environment proximate personal audio device 10 as described herein. As described further herein, sensor system 36 can include a plurality of distinct sensor types for detecting location-based conditions proximate the personal audio device 10 as well as detecting various user activities.

According to various implementations, the audio playback devices (which may be, for example, personal audio device 10 of FIG. 1) described herein can be configured to provide audio messages according to one or more factors. These particular implementations can allow a user to experience dynamic, personalized audio content in response to different environmental characteristics, e.g., as a user travels from one location to another location as part of an augmented reality experience. These implementations can enhance the user experience in comparison to conventional audio systems, e.g., portable audio systems or audio systems spanning distinct environments.

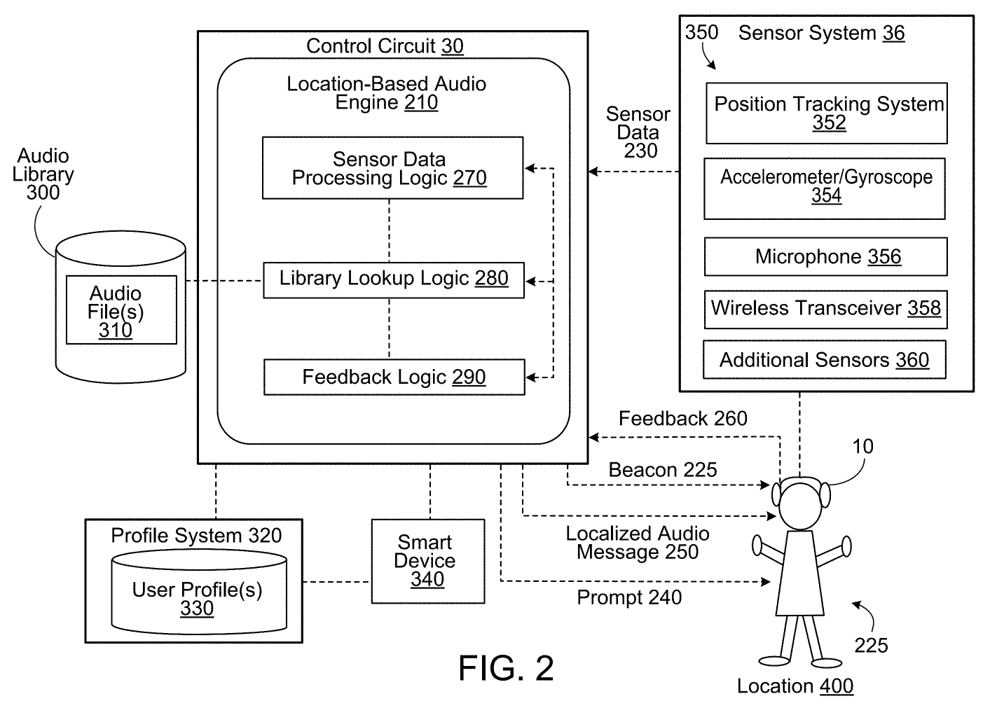

As described with respect to FIG. 1, control circuit 30 can execute (and in some cases store) instructions for controlling location-based audio functions in personal audio device 10 and/or other audio playback devices in a network of such devices. As shown in FIG. 2, control circuit 30 can include a location-based audio engine 210 configured to implement modifications in audio outputs at the transducer (e.g., speaker) 28 (FIG. 1) in response to a change in location-based or other conditions. In various particular embodiments, location-based audio engine 210 is configured to receive data about an environmental condition from sensor system 36, and modify the audio output at transducer(s) 28 in response to environmental conditions or a change in environmental conditions. In particular implementations, the audio output includes an audio message provided in response to a particular stimuli, such as a specific geographic location, or proximate a specific geographic location, an audio cue, a beacon, or other stimuli. The audio message which is configured to vary with the change(s) in location and/or environmental condition. In certain cases, the localized audio message can only be provided to the user at or proximate the geographic location, providing an immersive experience at that location.

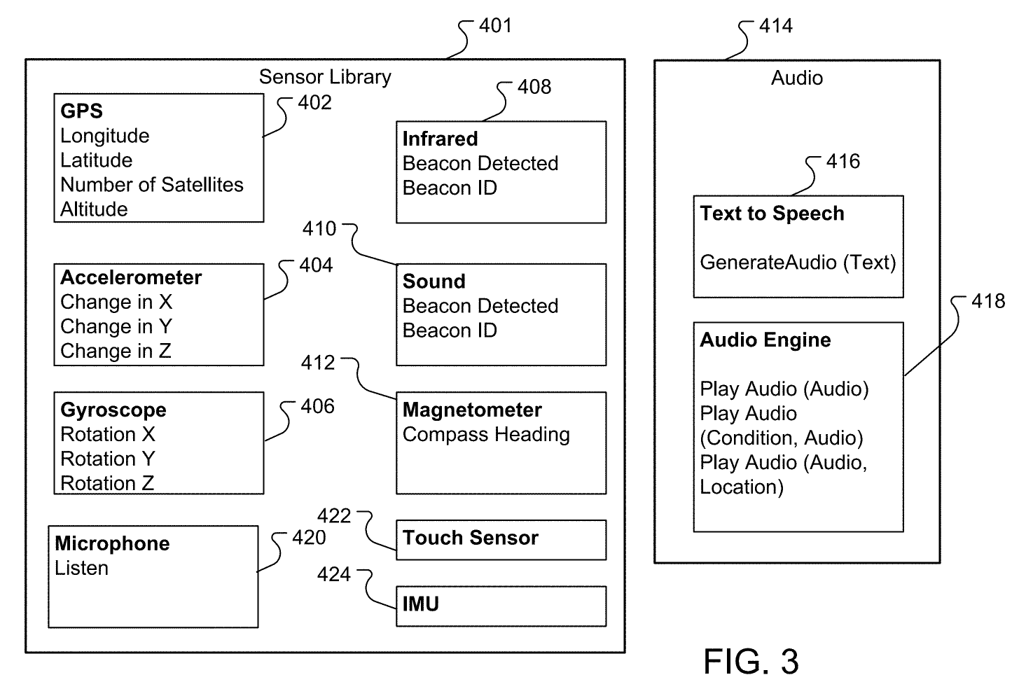

In particular, FIG. 2 shows a schematic data flow diagram illustrating a control process performed by audio engine 210 in connection with a user 225. It is understood that in various implementations, user 225 can include a human user. FIG. 3 shows an environment that includes a cloud based system that provides audio messages associated with one or more brands (e.g., advertisements for brand products, services, etc.) FIGS. 1-6 are referred to simultaneously.

Returning to FIG. 2, data flows between location-based audio engine 210 and other components in personal audio device 10 are shown. It is understood that one or more components shown in the data flow diagram may be integrated in the same physical housing, e.g., in the housing of personal audio device 10, or may reside in one or more separate physical locations.

According to various implementations, control circuit 30 includes the location-based audio engine 210, or otherwise accesses program code for executing processes performed by audio engine 210 (e.g., via network interface 34). Location-based audio engine 210 can include logic for processing sensor data 230 (e.g., receiving data indicating the location of the personal audio device, the proximity of personal audio device 10 to a geographic location, the direction of the user of the personal audio device is facing, etc.) from sensor system 36, and providing a prompt 240 to the user 225 to initiate playback of an audio message 250 (a localized audio message) to the user 225 at the personal audio device 10. In various implementations, in response to actuation (e.g., feedback 260) of the prompt 240 by the user 225, the location-based audio engine 210 initiates playback of the localized audio message 250 at the personal audio device 10. In additional implementations, location-based audio engine 210 can provide a beacon 255 to user 225 to indicate a direction of a localized audio message 250 based upon the sensor data 230. The beacon 255 may indicate the direction of the audio message by modifying the audio message to sound as if it is coming from a particular direction, relative to the direction in which the user 225 is looking. In some cases, this logic can include sensor data processing logic 270, library lookup logic 280 and feedback logic 290.

Location-based audio engine 210 can be coupled (e.g., wirelessly and/or via hardwired connections in personal audio device 10) with an audio library 300, which can include audio files 310 for playback (e.g., streaming) at personal audio device 10 and/or a profile system 320 including user profiles 330 about one or more user(s) 225. Audio library 300 can include any library associated with digital audio sources accessible via network interface 34 (FIG. 1) described herein, including locally stored, remotely stored or Internet-based audio libraries. Audio files 310 can additionally include audio pins or caches created by other users, audio information provided by automated agents, and made accessible according to various functions described herein. User profiles 330 may be user-specific, community-specific, device-specific, location-specific or otherwise associated with a particular entity such as user 225. User profiles 330 can include user-defined playlists of digital music files, audio messages stored by the user 225 or another user, or other audio files available from network audio sources coupled with network interface 34 (FIG. 1), such as network-attached storage (NAS) devices, and/or a DLNA server, which may be accessible to the personal audio device 10 (FIG. 1) over a local area network such as a wireless (e.g., Wi-Fi) or wired (e.g., Ethernet) home network, as well as Internet music services such as Pandora®, vTuner®, Spotify®, etc., which are accessible to the audio personal audio device 10 over a wide area network such as the Internet. In some cases, profile system 320 is located in a local server or a cloud-based server, similar to any such server described herein. User profile 330 may include information about frequently played audio files associated with user 225 or other similar users (e.g., those with common audio file listening histories, demographic traits or Internet browsing histories), “liked” or otherwise favored audio files associated with user 225 or other similar users, frequency with which particular audio files are changed by user 225 or other similar users, etc. Profile system 320 can be associated with any community of users, e.g., a social network, subscription-based music service (such as a service providing audio library 255), and may include audio preferences, histories, etc. for user 225 as well as a plurality of other users. In particular implementations, profile system 320 can include user-specific preferences (as profiles 330) for audio messages and/or related notifications (e.g., beacons or beckoning messages). Profiles 330 can be customized according to particular user preferences, or can be shared by users with common attributes.

Location-based audio engine 210 can also be coupled with a smart device 340 that has access to a user profile (e.g., profile 330) or biometric information about user 225. It is understood that smart device 340 can include one or more personal computing devices (e.g., desktop or laptop computer), wearable smart devices (e.g., smart watch, smart glasses), a smart phone, a remote control device, a smart beacon device (e.g., smart Bluetooth beacon system), a stationary speaker system, etc. Smart device 340 can include a conventional user interface for permitting interaction with user 225, and can include one or more network interfaces for interacting with control circuit 30 and other components in personal audio device 10 (FIG. 1). In some example implementations, smart device 340 can be utilized for: connecting personal audio device 10 to a Wi-Fi network; creating a system account for the user 225; setting up music and/or location-based audio services; browsing of content for playback; setting preset assignments on the personal audio device 10 or other audio playback devices; transport control (e.g., play/pause, fast forward/rewind, etc.) for the personal audio device 10; and selecting one or more personal audio devices 10 for content playback (e.g., single room playback or synchronized multi-room playback). In some cases smart device 340 may also be used for: music services setup; browsing of content; setting preset assignments on the audio playback devices; transport control of the audio playback devices; and selecting personal audio devices 10 (or other playback devices) for content playback. Smart device 340 can further include embedded sensors for measuring biometric information about user 225, e.g., travel, sleep or exercise patterns; body temperature; heart rate; or pace of gait (e.g., via accelerometer(s).

The location-based audio engine 210 can be coupled with external sensors, including but not limited to cameras, GPS devices, gyroscopes, magnetometers, accelerometers, etc. In some implementations, the sensors may be within secondary devices in communication with the augmented-reality audio engine 210. For example, the sensors may be included in a smart device, in a headset, glasses, or other similar device. The augmented-reality audio engine can be configured to play particular audio, either pre-recorded or machine generated.

Location-based audio engine 210 can be configured to receive sensor data 230 about distinct locations or other sensor signals from sensor system 36. Sensor data 230 is described herein with reference to the various forms of sensor system 36 configured for sensing such data.

As shown in FIG. 2, sensor system 36 can include one or more of the following sensors 350: a position tracking system 352; an accelerometer/gyroscope/magnetometer 354; a microphone (e.g., including one or more microphones) 356 (which may include or work in concert with microphones 18 and/or 24); and a wireless transceiver 358. These sensors are merely examples of sensor types that may be employed according to various implementations. It is further understood that sensor system 36 can deploy these sensors in distinct locations and distinct sub-components in order to detect particular environmental information relevant to user 225.

The position tracking system 352 can include one or more location-based detection systems such as a global positioning system (GPS) location system, a Wi-Fi location system, an infra-red (IR) location system, a Bluetooth beacon system, etc. In various additional implementations, the position tracking system 352 can include an orientation tracking system for tracking the orientation of the user 225 and/or the personal audio device 10. The orientation tracking system can include a head-tracking or body-tracking system (e.g., an optical-based tracking system, accelerometer, magnetometer, gyroscope or radar) for detecting a direction in which the user 225 is facing, as well as movement of the user 225 and the personal audio device 10. Position tracking system 352 can be configured to detect changes in the physical location of the personal audio device 10 and/or user 225 (where user 225 is separated from personal audio device 10) and provide updated sensor data 230 to the location-based audio engine 210 in order to indicate a change in the location of user 225. Position tracking system 352 can also be configured to detect the orientation of the user 225, e.g., a direction of the user's head, or a change in the user's orientation such as a turning of the torso or an about-face movement. In some example implementations, this position tracking system 352 can detect that user 225 has moved proximate a location 400 with a localized audio message 250, or that the user 225 is looking in the direction of a location 400 with a localized audio message 250. In particular example implementations, the position tracking system 352 can utilize one or more location systems and/or orientation systems to determine the location and/or orientation of the user 225, e.g., relying upon a GPS location system for general location information and an IR location system for more precise location information, while utilizing a head or body-tracking system (e.g., an accelerometer/gyroscope/magnetometer) to detect a direction of the user's viewpoint. In any case, position tracking system 352 can provide sensor data 230 to the location-based audio engine 210 about the position (e.g., location, orientation, and/or head direction) of the user 225.

The accelerometer/gyroscope/magnetometer 354 can include distinct accelerometer components, gyroscope, and magnetometer components, or could be collectively housed in a single sensor component. This component may be used to sense gestures based on movement of the user's body (e.g., head, torso, limbs) while the user is wearing the personal audio device 10 or interacting with another device (e.g., smart device 340) connected with personal audio device 10, and to sense the direction a user's head is facing. This component may also be used to sense gestures based on interaction between the user and the audio device, such as taping on the audio device. As with any sensor in sensor system 36, accelerometer/gyroscope/magnetometer 354 may be housed within personal audio device 10 or in another device connected to the personal audio device 10. In some example implementations, the accelerometer/gyroscope/magnetometer 354 can detect an acceleration of the user 225 and/or personal audio device 10 or a deceleration of the user 225 and/or personal audio device 10.

The microphone 356 (which can include one or more microphones, or a microphone array) can have similar functionality as the microphone(s) 18 and 24 shown and described with respect to FIG. 1, and may be housed within personal audio device 10 or in another device connected to the personal audio device 10. As noted herein, microphone 356 may include or otherwise utilize microphones 18 and 24 to perform functions described herein. Microphone 356 can be positioned to receive ambient audio signals (e.g., audio signals proximate personal audio device 10). In some cases, these ambient audio signals include speech/voice input from user 225 to enable voice control functionality. In some other example implementations, the microphone 356 can detect the voice of user 225 and/or of other users proximate to or interacting with user 225. In particular implementations, location-based audio engine 210 is configured to analyze one or more voice commands from user 225 (via microphone 356), and modify the localized audio message 250 based upon that command. In some cases, the microphone 356 can permit the user 225 to record a localized audio message 250 for later playback at the location by the user 225 or another user. In various particular implementations, the location-based audio engine 210 can permit the user 225 to record a localized audio message 250 to either include or exclude ambient sound (e.g., controlling ANR during recording), based upon the user preferences. In some examples, user 225 can provide a voice command to the location-based audio engine 210 via the microphone 356, e.g., to control playback of the localized audio message 250. In these cases, sensor data processing logic 270 can include logic for analyzing voice commands, including, e.g., natural language processing (NLP) logic or other similar logic.

Returning to sensor system 36, wireless transceiver 358 (comprising a transmitter and a receiver) can include, for example, a Bluetooth (BT) or Bluetooth Low Energy (BTLE) transceiver or other conventional transceiver device, and may be configured to communicate with other transceiver devices in distinct locations. In some example implementations, wireless transceiver 358 can be configured to detect an audio message (e.g., an audio message 250 such as an audio cache or pin) proximate personal audio device 10, e.g., in a local network at a geographic location or in a cloud storage system connected with the geographic location 400. For example, another user, a business establishment, government entity, tour group, etc. could leave an audio message 250 (e.g., a song; a pre-recorded message; an audio signature from: the user, another user, or an information source; an advertisement; or a notification) at particular geographic (or virtual) locations, and wireless transceiver 358 can be configured to detect this cache and prompt user 225 to initiate playback of the audio message.

As noted herein, in various implementations, the localized audio message 250 can include a pre-recorded message, a song, or an advertisement. However, in other implementations, the localized audio message can include an audio signature such as a sound, tone, line of music or a catch phrase associated with the location at which the audio message 250 is placed and/or the entity (e.g., user, information source, business) leaving the audio message 250. In some cases, the localized audio message 250 can include a signature akin to an “audio emoji”, which identifies that localized audio message 250, e.g., as an introduction and/or closing to the message. In these examples, an entity could have a signature tone or series of tones indicating the identity of that entity, which can be played before and/or after the content of the localized audio message 250. These audio signatures can be provided to the user 225 (e.g., by location-based audio engine 210) generating the localized audio message 250 as standard options, or could be customizable for each user 225. In some additional cases, the localized audio message 250 can be editable by the user 225 generating that message. For example, the user 225 generating a localized audio message 250 can be provided with options to apply audio filters and/or other effects such as noise suppression and/or compression to edit the localized message 250 prior to making that localized message 250 available (or, “publishing”) to other user(s) 225 via the location-based audio engine 210. Additionally, the localized audio message 250 can enable playback control (e.g., via location-based audio engine 210), permitting the listening user 225 to control audio playback characteristics such as rewind, fast-forward, skip, accelerated playback (e.g., double-time), etc.

In particular example implementations, the user 225 can “drop” a localized audio message 250 such as a pin when that user 225 is physically present at the geographic location 400. For example, the user 225 can share a live audio recording, sampled using microphone 356 or another microphone to provide a snapshot of the audio at that location 400. This localized audio message 250 can then be associated (linked) with the geographic location 400 and made available to the user 225 or other users at a given time (or for a particular duration) when those users are also proximate the geographic location 400. In other example, the localized audio message 250 can be generated from a remote location, that is, a location distinct from the geographic location associated with the localized audio message 250. In these cases, the provider of the localized audio message 250 can link that message 250 with the geographic location via the location-based audio engine 210, such as through a mobile application or PC-based application of this engine 210. As described herein, access to localized audio message(s) 250 and creation of such message(s) 250 can be tailored to various user and group preferences. However, according to various implementations, the localized audio message 250 is only accessible to a user 225 that is proximate the geographic location associated with that message 250, e.g., a user 225 physically located within the proximity of the geographic location.

It is understood that any number of additional sensors 360 could be incorporated in sensor system 36, and could include temperature sensors or humidity sensors for detecting changes in weather within environments, optical/laser-based sensors and/or vision systems for tracking movement or speed, light sensors for detecting time of day, additional audio sensors (e.g., microphones) for detecting human or other user speech or ambient noise, etc.

A software development kit (SDK) can be provided. An SDK can be a collection of pre-coded modules that enable a developer to create custom applications and experiences for use with the location-based audio engine by third party programmers. The SDK can enable programmers to access sensor data and use the sensor data to cause audio messages to be played (and potentially generated) in response to various combinations of sensor data.

In some implementations, the SDK can enable programmers to allow a user to record audio associated with various combinations of sensor data. The SDK can provide a layered framework that defines a plurality of interacting software layers for communicating audio and sensor data between sensor devices and the location based audio engine. The SDK can enable a programmer to specify one or more actions to take in response to particular signals or combination of signals from the sensors. In some implementations, the SDK can enable the programmer to register interest in a particular combination of signals. For example, the SDK may enable the user to request notification when the audio engine is at a particular location (for example, a longitude and latitude), when the user looks in a particular direction (for example, south and up), etc. In some implementations, the SDK can enable the programmer to register an interest in a combination of signals from different sensors (for example, the user is at a particular location looking in a particular direction.)

In some implementations, the SDK standardizes the access of a variety of different types of sensors. For example, the sensor data may be provided in a standard XML or JSON format. Events may be mapped into integer values encoded within the SDK for easy access comparison and translation. In some implementations, the SDK may be organized into classes or packages. In one example, each class may provide an interface to a different type of sensor. For example, a GPS class may provide access to current sensor data from a GPS device, while a gyroscope class may process access to current sensor data from a gyroscope.

In some implementations, the sensor classes may raise events or create callbacks when a particular set of circumstances occur; for example, if a user is at a particular location. In other implementations, an application developer may need to poll a sensor to receive data. However, it is frequently more efficient to have the SDK obtain the sensor data periodically and provide it to the application. In this way, the SDK can limit how frequently different sensor data is obtained and thereby preserve the battery life of mobile devices.

FIG. 3 illustrates an example of a portion of an SDK to enable augmented reality audio. The SDK may include, for example, a sensor library 401. The sensor library 401 may include classes, programs, libraries, etc., representing different types of sensors. For example, the sensor library 401 may include a GPS sensor class 402. The GPS sensor class 402 may be able to provide the current longitude and latitude of the device, as well as the number of satellites the GPS device can contact and the current altitude of the GPS device.

The sensor library 401 may also include an accelerometer class. The accelerometer class 404 may be able to provide the current change in acceleration in three cardinal directions, referred to as X, Y, and Z. The sensor library 401 may also include a gyroscope class 406. The gyroscope class may be able to provide the current rotation around three cardinal axis, referred to as X, Y, and Z.

The sensor library 401 may also include an infrared class 408. The infrared class 408 may include the ability to detect infrared beacons and provide a beacon ID. Similarly, the sensor library 401 may also include a sound class 410. The sound class 410 may be able to detect audio beacons (for example, beacons that are outside the range of human hearing) and an identifier associated with the beacon.

The sensor library 401 may also include a magnetometer class 412. The magnetometer class 412 may be able to provide the current detected compass heading (e.g., the strength of the Earth's magnetic field in three axes, referred to as X, Y, and Z).

Other sensors may also be integrated in to the SDK. For example, the SDK may include sensors that enable a user to interact with the system. Two examples include a microphone 420 and a touch sensor 420. Each of these sensors may be used to receive commands from a user of the audio device.

It should be understood that each of the exemplary classes described above provides a programmatic interface to physical sensors in communication with the audio engine. The communication may be wired or wireless. The sensors may be integrated into an audio device that includes the audio engine or may be included in another device that is in communication with the audio device that includes the audio engine. Further, the sensors described above are a representative sample of sensors that may be integrated with the audio device. Other sensors may also be used, including but not limited to, a camera or an inertial measurement unit 424.

The SDK may also include an audio library 414. The audio library 414 may include classes that provide access to audio tools, for example, a text to speech class 416 may provide the programmer the ability to generate synthetic speech based on a text string.

The SDK may also include a class to access the audio engine 418. The audio engine class 518 may provide the programmer with the ability to cause audio to be played. Playing the audio may be conditional on sensor data provided by one or more of the sensors. In some implementations, the audio engine 418, may include the ability to cause the audio to appear to come from a particular direction (left or right in the case of stereo or from a particular location in the case of surround sound or simulated surround sound, or when spatializing the audio so that it appears to be heard in the direction it is actually occurring in space).

In some implementations, the SDK may include functions related to the direction the user is looking. For example, the SDK may enable a programmer to select different audio programs based on the direction a user is looking. For example, if the user is looking in a 30 degree arc in a first direction, one audio sample plays, if the user is looking from 15-45 degrees in a second direction, a different audio sample plays.

In this manner, the programmer can enable the user to select between different audio samples. For example, the SDK may enable the programmer to create an application that determines sensor information in response to an action taken by a user. For example, if the user activates a touch sensor, the programmer can create a program that captures the direction the user is facing and uses that information to select a particular audio file or set of audio files. Detail describing a particular embodiment of directional audio selection is described in U.S. patent application Ser. No. ______, filed Feb. 28, 2018 (Atty. Dkt. No. OG-18-035-US) entitled “Directional Audio Selection”, the disclosure of which is incorporated herein by reference in its entirety.

In general, the SDK may include a plurality of pre-coded API sensor modules for obtaining information from the sensors coupled to a mobile device and a pre-coded API audio module for playing audio content based on the information obtained from at least one of the sensors. The audio content may be a playlist, an audio stream, internet radio, or any playable audio file.

In some implementations, sensor module may be capable of receiving an initiation command, and the initiation command may be a tactile actuation, gesture actuation or a voice command at the wearable audio device or another device. The initiation command can be used, for example, to trigger audio content to play.

The SDK may be provided as a collection of libraries. For example, the SDK may be provided as a dynamic link library (DLL), a JAVA archive (JAR), a PYTHON library, etc. In some implementations, the SDK may be designed to integrate with an integrated development environment (IDE). In general, an IDE is a software application that provides a robust set of utilities to computer programmers for software development. An IDE normally consists of a source code editor, build automation tools, and a debugger. Some IDEs provide the capability to integrate with additional toolkits using plug-ins. Plug-ins contribute functionality to the IDE by providing pre-defined extension points. In some implementations, an IDE includes a platform runtime, which can dynamically discover registered plug-ins and start them as needed. The SDK may be integrated into such a plug-in.

In some implementations, the SDK may be packaged with other software applications. For example, the SDK may be integrated into an operating system of a smart device, virtual reality headset, computer, or other device capable of executing an augmented reality audio program.

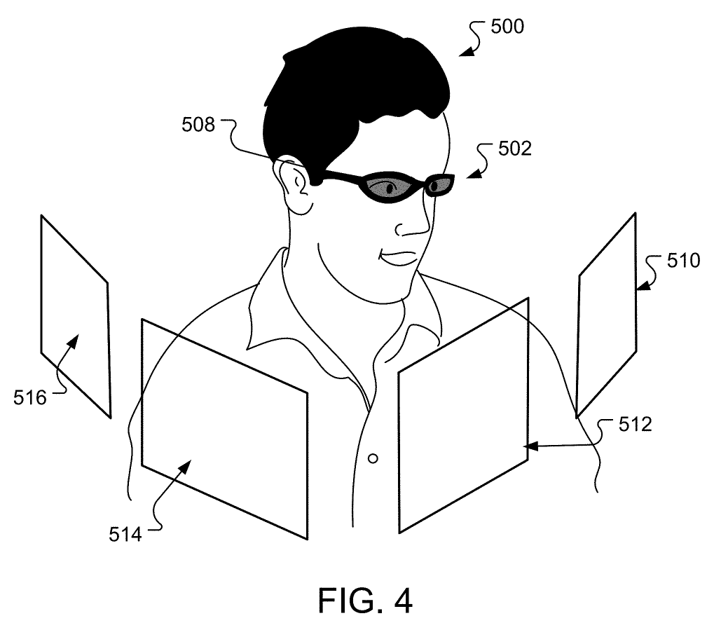

One example of using such a feature is to enable a user to select a particular language channel on a guided tour. FIG. 4 illustrates a user selecting a language channel for an audio guided tour. In this example, a user 500 is wearing smart glasses 502 with integrated sensors that enable an audio engine (now shown) to determine the direction the user is facing and to play a corresponding audio sample. For example, when the user is facing toward the 510 direction, the user may hear an instruction to provide an input in French (for example, by touching a touch sensor 508 integrated into the smart glasses 502). When the user is facing in the 512 direction, the instructions may be in English. When the user is facing in the 514 direction, the instructions may be in Spanish, and when the user is facing in the 516 direction, the instructions may be in German.

When the user touches the touch sensor 508 the direction the user is facing, and the corresponding language selection, is recorded.

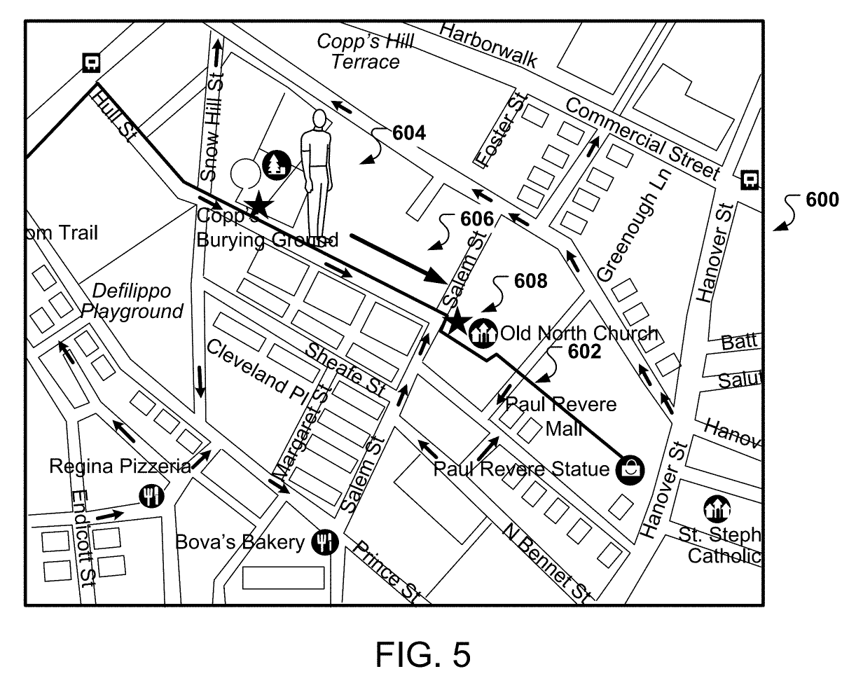

FIG. 5 continues the example of the augmented reality audio guided tour. The guided tour is one application that can be created using the SDK and is described briefly for exemplary purposes. A map 600 of the freedom trail 602 in 600 is presented. In this example, a user 604 walks along the freedom trail in the direction represented by the directional arrow 606 toward the Old North Church (represented by the location 608). As the user approaches the church, the audio device may detect, based on accelerometer and the GPS location, that the user is approaching from the north west. Accordingly, audio may play informing the user that the Old North Church is up ahead on the left. In some implementations, the audio may seem to the user to be coming from the Old North Church itself, further focusing the user's attention.

If, on the other hand, the user had been approaching the Old North Church from the opposite direction, the audio device would detect the direction and location of the user and inform the user that the Old North Church is up ahead on the right. In this manner, the audio experience may be customized for the user. If the user were approaching the Old North Church, but looking at something else (e.g., a coffee shop across the street), the audio device would detect the direction of the user's gaze, and instead may provide audio about the specific object the user is looking at (e.g., inviting the user in to try a coffee at the coffee shop)

In some development efforts, for which the SDK is utilized, different type of audio content can be provided to a user. For example, audio assets (e.g., deliverable audio files) can be created for delivery to a wearable audio device (e.g., audio device 10) for playing to a user. The audio assets can include segments (referred to as slots) within which different types of audio can be inserted. For example, an audio asset may include an audible description of the current scene being viewed by the user (e.g., a description of buildings, landscape, etc. in the user's field of view). One or more segments may be interspersed along the audible description, and each segment is capable of receiving data that represents audio content. For example, a segment may be placed after every ten minutes of the audible description. Different types of audio content may be inserted into these slots; for example, audio advertisements can be inserted and each advertisement can relate to the current location of the user, the current direction the user is facing, etc. Based upon the development using the SDK and system components, appropriate audio content can be inserted into the segments along with other operations being executed. For example, user feedback to the audio inserted into the segments (e.g., audio advertisements) can be collected and analyzed (e.g., identify advertisements to brand owners that initiated user action).

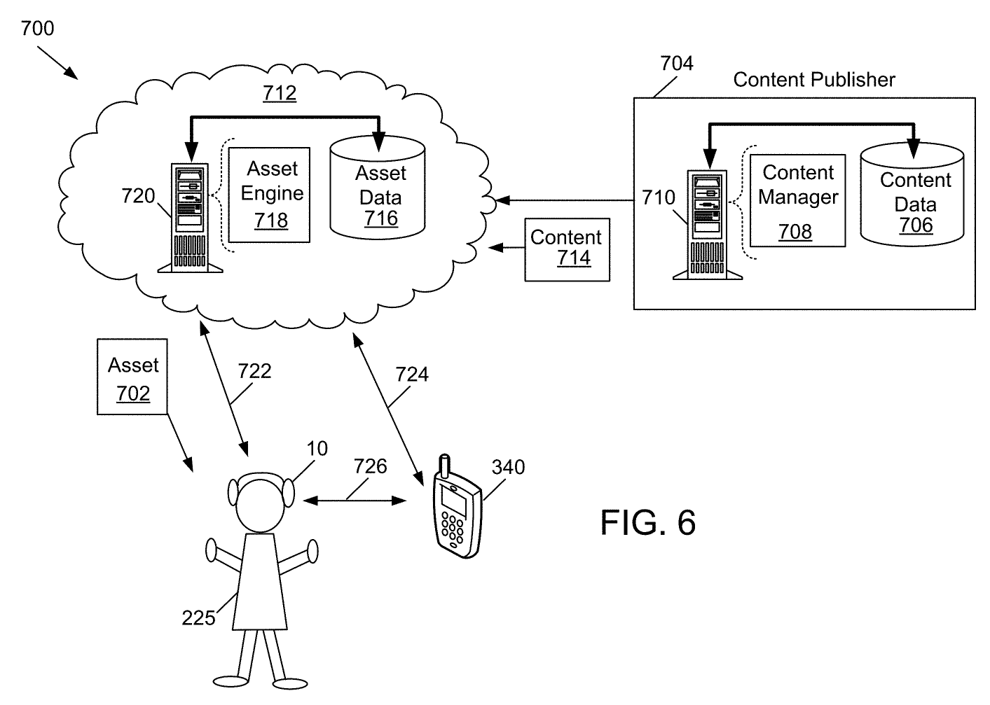

Referring to FIG. 6, a computational environment 700 is illustrated that graphically depicts the interacting of entities and systems to deliver location based audio. Audio content is provided to the user 225 by the personal audio device 10 (e.g., a headset, other type of wearable device, etc.). An asset 702 is developed to provide audio, for example, based upon the location of the user 225, facing direction of the user, etc. One or more sources can provide the audio content that is packaged and sent in the asset 702; for example, a content publisher 704 can manage content (e.g., audio advertisements) of one or more brands associated with products, services, etc. In the illustrated example, information is stored at the content publisher 704 (e.g., content data is stored in a storage device 706 located at the content publisher 704). Such content may include visual content (e.g., images, videos, etc.), audio content (e.g., recordings, etc.) associated with the branded products, services, etc. A content manager 708 is executed by a computer system 710 located at the content publisher 704 to manage the brand associated content. For example, content collection and creation can be managed along with the distribution of the content through a variety of communication channels. Some content may be allowed for distribution through visual communication channels (e.g., presented on webpages, television advertisements, etc.) while other content such as audio content can be distributed through audio communication channels (e.g., provided to the personal audio device 10) for playing to the user 225.

In the illustrated environment 700, audio content (for use in one or more advertisements) is provided to a cloud based system 712 from the content publisher 704. In general, the cloud computing system 712 can use a network of remote servers hosted on one or more networks (e.g., the Internet) to store, manage, and process data, rather than a local server or a personal computer. In this example, a file 714 is used to transfer the audio content to the cloud computing system 712; however, multiple files may be employed for transferring the content (e.g., data representing audio content). While a file transfer system is used for this particular arrangement, one or more other data transfer techniques may be used. Delivered to the cloud 712, the content (e.g., audio content) is stored within the resources of the cloud (e.g., stored on a storage device 716) and is accessible by an asset engine 718 that is executed by a computer system 720 based in the cloud 712. For example, the asset engine 718 may populate segments (slots) of an audio asset (e.g., created by using the SDK) prior to delivering or after delivery of the asset to the audio device 10 for listening by the user 225. For example, one or more files containing the audio content of the asset 702 may be sent from the cloud 712 to the audio device 10. In one potential alternative embodiment, one or more links (rather than data) may be provided to the audio device 10. By accessing the link (or links) at the audio device 10, audio content may be retrieved from one or more sources (e.g., the cloud 712, the content publisher 704), etc. Along with audio, one or more other types of content may sent to the audio device 10. For example, an advertisement may be sent that includes both audio content and visual content. In one arrangement, one or more files is sent from the cloud 712 that contain both visual and audio data associated with an advertisement. For example, an asset may be developed that contains slots for audio advertisement content and also slots for visual advertisement content. Once the slots are populated (e.g., audio and visual slots are populated after delivery), the audio portion of the asset can be played by the audio device 10 and the visual portion of the asset can be presented by the smart device 340. In some instances, data may be exchanged between the devices for appropriately providing the content the user 225 (e.g., the audio device 10 may pass the visual content to the smart device 340 for presentation, the smart device 340 may pass the audio content to the audio device 10 for playback).

Once the asset 702 with the audio slot (or slots) is delivered to the audio device 10, audio content can be selected for inserting into the audio slot (or slots). In a similar manner, once the smart device 340 receives the asset 702, visual content can be selected for insertion on the visual slot (or slots) for presentation on a display of the smart device 340. Focusing on the selection of the audio content, one or more techniques may be employed. For example, one or more parameters may factor into the selection of the audio content to populate an audio slot. One parameter may be the geolocation of the user 225; for example, the location of the user (e.g., standing outside a storefront) can weigh heavily on audio content selection (e.g., select audio content about the store, the types of products or services available, etc.). The direction that the user 225 is facing can also factor into selection; for example, if the user is facing at a particular building, storefront display, etc., audio content associated with the current view of the user may be retrieved and used to populate the audio slot. Techniques used to determine geolocation and user facing direction and may be found in U.S. patent application Ser. No. ______, filed on Feb. 28, 2018 (Atty. Dkt. No. OG-18-035-US) entitled “Directional Audio Selection”, the disclosure of which is incorporated herein by reference in its entirety.

Other types of parameters that are reflective of the focus of the user (e.g., geolocation, direction facing, etc.) may also be used for audio content selection. For example, one or more preferences associated with the user 225 such as preferences for brands, products, services, etc. can be used for the audio selection, or preferences for the types of audio content based on the user's current state (e.g., walking to work, sightseeing, exercising, etc. —each of which may trigger different types of audio content). Briefly referring to FIG. 2, the profile system 320 may be accessible by the cloud computing system 712 and allow one or more profiles associated with the user 225 to be investigated for preferences. Such preferences can be directly attained from the user (e.g., via polling, product questionnaires, feedback, etc.) or indirectly attained (e.g., through data representing prior purchases, click data representing interactions with product and service websites, etc.). Modeling efforts may also be used to determine likely preferences of the user 225; for example, based upon demographics of the user, purchase history, etc. one or more preferences of the user may emerge.

Distance to particular locations can also affect the audio content that is selected; for example, as the user closes the distance to a particular location, audio content associated with the location (e.g., an audio advertisement for an upcoming store may be played as the user get closer). Other parameters selectable by the asset engine 718 may be associated with the language that the audio content is played. For example, the natural language of the user 225 can be identified, for example, from the user profiles 330 (shown in FIG. 2) and correspondingly selected for the audio content.

Along with the selection of the audio content for populating the audio slot (or slots), other types of parameters may be selected, controlled, etc. for playing the audio content in an audio slot of the advertisement. The parameters are typically set by the asset engine 718 being executed by the computer system 720 located in the cloud 712; however, in some arrangements parameter setting may occur locally at the audio device 10, the smart device 340, in a distributed manner (e.g., operations executed by the asset engine 718 and the audio device 10), etc. One parameter accounts for other audio that can be heard by the user 225 as the audio advertisement is played (e.g., another audio signal being provided through the audio device 10, ambient sounds from the surrounding environment, etc.). In one arrangement, the audio advertisement content can be considered a layer of audio that is played to the user 225 along with one or more other layers of audio heard by the user (e.g., ambient sounds from the environment, other audio content provided by the cloud 712, etc.), thereby allowing the user to be aware of different audio signals. In such an arrangement, the audio advertisement may be played simultaneously with one or more other layers of audio, and the volume of the one or more other layers of audio may be temporarily lowered to focus the user's attention on the audio advertisement layer. In another arrangement, the audio content of the advertisement is solely played to the user 225 and any other audio content is absent. For example, audio content currently being provided to the user 225 through the audio device 10 is halted and is solely replaced by the audio content of the advertisement.

Another parameter may be associated with the frequency that the audio content is played by the audio device to the user 225. For example, the audio may be played with a higher frequency for subjects that are preferred by the user (e.g., as determined from user preference data). Audio content may also be played at higher frequency for locations that the user has not previously visited or less frequently visits. The frequency that content is played to the user 225 can also be driven by the relationship between the user and the content; for example, the history between the user and the brand associated with content. If the user 225 has a long-standing relationship with the brand (e.g., often reviews products, services, etc. of the brand, has a purchase history with the brand, etc.), the audio content associated with the brand may be more frequently provided to the user. User profile information (e.g., stored in the user profile 330), user preferences, etc. can provide an indication of a user's interest and history with a brand. Data from other sources can also be used to identify the history a brand and users; for example, content publishers such as content publisher 302 can collect data that represents interactions between users and different brands. Different programs, policies, etc. can be instituted by a brand based upon user interactions with the brand products, services, etc. For example, based on their interactions, user may be identified as a loyal customer and this information can be provided to the cloud 712 for use in determining which audio content to provide to the user (e.g., audio advertisements of a brand that the user has a long history), the frequency that particular content should be provided to the user, whether the audio should be played to the user as one of multiple layers of audio (or played absent any other audio), etc.

In some arrangements, data is provided to the cloud 712 to assist with selecting the content for inserting in the slots of the asset. For example, geolocation data, user facing direction data, etc. is provide by the audio device 10, the audio device 340, etc. as graphically represented by arrows 722 and 724. Once the audio content has been selected by the asset engine 718, data that represents the asset and content inserted into the slots (e.g., an audio advertisement) is sent to the audio device 10 being wore by the user (also graphically represented by arrow 722). Typically, one or more files are sent to provide the audio content; however, different types of data transmission techniques may be employed. In some instances, the asset 702 is sent to the smart device 340 of the user (as graphically represented by arrow 724), which in turn may be shared with the audio device 10 (as graphically represented by arrow 726). For instances, that the asset 702 includes an audio portion (e.g., an audio advertisement) and a visual portion (e.g., imagery, graphics, etc. associated with the audio advertisement), the audio portion is played to the user 225 (through the audio device 10) while the visual portion is presented on the display of the smart device 340. In instances where the audio device 10 also includes a display (e.g., as may be the case if the audio device 10 is a pair of glasses), the visual portion may be presented on the display of the audio device. Along with providing additional information, displaying the visual portion can allow the user 225 to interact with the smart device 340 (e.g., pursue further information about the brand product, services, etc., initiate a purchase of an advertised product, service, etc.).

Once the asset is presented to the user 225 (e.g., the audio content is played by the audio device 10, the visual content is presented on the smart device 340), any response from the user can be collected and used in one or more applications. For example, data representing the response of the user 225 can be collected and provided to the content publisher 704 for feedback analysis (e.g., identify the brand products, services, etc. that resonated with the user). Various types of responses may be collected from the user 225; for example, data may be collected from the audio device 10 (e.g., data representing user gestures as provided by sensors included in the audio device, data about which direction the user walks or looks after hearing the audio content). User interactions with the smart device 340 can also be collected and provided to the content publisher 704 for feedback analysis. Such feedback data can be provided to the content publisher 704 directly from the user 225 (e.g., data is sent from the audio device 10, the smart device 340, etc.) or indirectly from the user (e.g., representative data is initially sent to the cloud 712), and is then passed to the content publisher 704).

Potential user responses to the presented content, which can be collected, include no particular reaction (e.g., user 225 simply listens to the audio advertisement). In such instances, data can be collected (e.g., from the audio device 10, the smart device 340, etc.) that reflects the absence of a user reaction. For another type of reaction, as the audio content is being played the user 225 indicates to skip the audio (e.g., halt the current playing of audio). For this situation, once the audio playback stops, data representing this reaction can be provided to the cloud 310 to address the user's desire to skip the content. Once informed, one or more operations may be executed; for example, the audio advertisement can be queued for resending to the user 225 at a later time (e.g., the audio may be tagged for the next available slot). Data may also be sent to the smart device 340 upon an indication that the user 225 has requested to skip the audio; for example, an email message or other type of communication may be sent to smart device for presenting information associated with the brand (e.g., an advertisement of the product, service, etc. mentioned in the audio advertisement). Along with providing information contained in the skipped audio content, such communications can also include data that provides additional information about the audio's content. For example, an email message may be sent to the smart device 340 that contains one or more links for the main website of the brand, the webpage(s) that describes the products, services, etc. that were highlighted in the skipped audio advertisement.

In other types of reactions, the user 225 may react positively to the audio advertisement played by the audio device 10. Similarly, data can be collected that reflects this type of reaction and can initiate the execution of operations. For example, the sensor system 36 of the audio device can generate signals indicative a positive gesture from the user 225 during or directly following the playing of the audio advertisement. Data representing this reaction can be collected and provided to the content publisher 704 (e.g., via the cloud 712) for feedback analysis. Positive reactions from the user 225 can include the user selecting the brand associated with the audio advertisement as being a favorite brand. By interacting with the audio device 10 (e.g., physically taping the device in a predefined manner), the smart device 340 (e.g., storing data to indicate the brand is now a favorite), or other devices (e.g., a smart watch), or a combination of devices, data can be generated to reflect the user's positive reaction to the audio advertisement. Provided this data, the cloud 712 can execute operations that use this user reaction; for example, the asset engine 718 can increase the frequency of inserting audio advertisements for this brand (e.g., audio advertisements associated with products, services, etc. of this brand and similar brands) into asset slots so the user 225 hears about the brand more often. Preference data, profile data, etc. associated with the user 225 may also be adjusted to reflect the user's positive reaction (e.g., store data in the user preferences that indicates the user considers this brand as a favorite).

Being presented the audio advertisement, the user 225 may also react by expressing an interest for more information associated with the content of the advertisement. For example, the user 225 may indicate by one or more gestures (e.g., a head nod, a particular tapping on or swiping across a portion of the audio device 10, a voice command, etc.) his or her interest in additional information. User interactions with the smart device 340 can also provide an indication of the user's interest for additional information about the brand, product, services, etc. Such interactions with the audio device 10, smart device 340, other devices (e.g., a smartwatch), combinations of devices, etc. can trigger the retrieval of additional information (e.g., from the cloud 712, the content publisher 704, etc.). As this additional data is provided to the user (e.g., via the audio device 10, the smart device 340, etc.), the user may be interested in still further information about the brand. Based on this interest, the user may perform further interactions with the audio device 10 (e.g., perform more detectable head gestures, tactile gestures, or voice commands), the smart device 340 (e.g., enter queries into a presented interface), or other devices (e.g., execute hand movements detectable by a smart watch or a sensor-embedded accessory being worn by the user). Through these additional interactions, the user 225 can drill down and investigate brand associated information in a “telescoping manner”. Other types of communications can also be sent to the user 225 to provide requested information as the user explores a brand or related topic (e.g., different product or service lines, etc.); for example, one or more types of messages may be sent to the user (e.g., texts messages, email messages, etc.). By providing this capability to “telescope” to different levels of details, a small snippet of information that is efficiently presented to the user can trigger an exploration of more information with relatively little effort by the user (e.g., simple head nods, hand movements, etc.) can navigate the user 225 to more detailed content including more audio content.

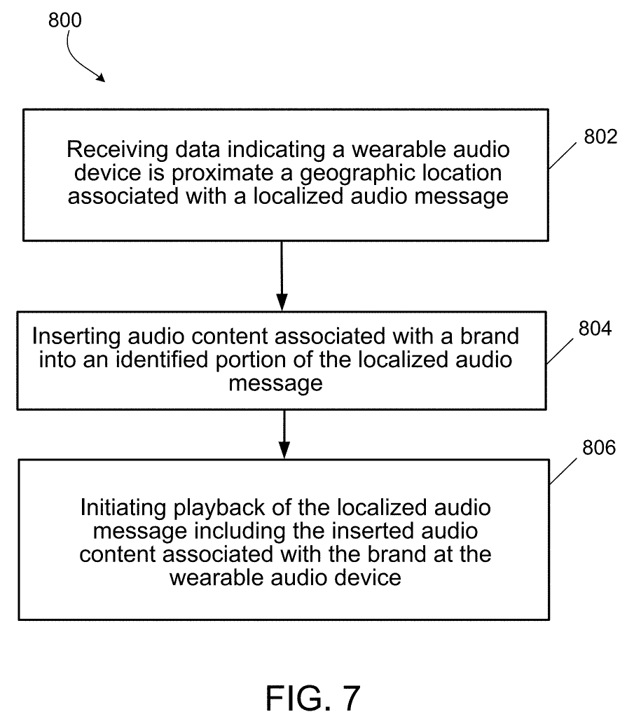

Referring to FIG. 7, a flowchart 800 represents operations of an asset engine (e.g., the asset engine 718 shown in FIG. 6) being executed by a computing device (e.g., the computer system 720 located at the cloud 712). Operations of the asset engine 718 are typically executed by a single computing device (e.g., the computer system 720); however, operations may be executed by multiple computing devices. Along with being executed at a single site (e.g., the cloud 712), the execution of operations may be distributed among two or more locations. In some arrangements, a portion of the operations may be executed at one or more computing devices located external to the cloud 712, etc.

Operations of the asset engine may include receiving 802 data indicating a wearable audio device is proximate a geographic location associated with a localized audio message. For example, the wearable audio device 10 (shown in FIG. 2) can provide data to the asset engine 802 that represents the location of the audio device. Operations also include, inserting audio content associated with a brand into an identified portion of the localized audio message. For example, audio content that represented an audio advertisement for a brand (e.g., a brand associated with a store within view of the wearer of the audio device, or a store a user is specifically looking at) can be inserted into an advertisement slot included in a message to be sent to the audio device. Operations also include, initiating playblack of the localized audio message including the inserted audio content associated with the brand at the wearable audio device. For example, the message containing the inserted audio advertisement can be delivered and played by the audio device to provide the audible content of the advertisement to the wearer of the audio device.

The audio device may also enable a single user interaction “shortcut” for a user to purchase goods or services associated with an audio advertisement. For example, if a Starbucks advertisement were played to a user about a special drink or promotion associated with a drink, a user could perform a specified user interaction at the audio device (or at another device in communication with the audio device) to indicate the user wishes to purchase the drink. Any suitable user interaction could be used, e.g., tactile actuation, gesture actuation or a voice command, and some interactions could provide for a secure transaction to occur, e.g., use of a fingerprint, voiceprint, or other gesture uniquely associated with the user (e.g., a signature gesture), which then triggers the secure payment for the goods or services.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

In various implementations, components described as being “coupled” to one another can be joined along one or more interfaces. In some implementations, these interfaces can include junctions between distinct components, and in other cases, these interfaces can include a solidly and/or integrally formed interconnection. That is, in some cases, components that are “coupled” to one another can be simultaneously formed to define a single continuous member. However, in other implementations, these coupled components can be formed as separate members and be subsequently joined through known processes (e.g., soldering, fastening, ultrasonic welding, bonding). In various implementations, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

A number of implementations have been described. Nevertheless, it will be understood that additional modifications may be made without departing from the scope of the inventive concepts described herein, and, accordingly, other embodiments are within the scope of the following claims.

We claim:

1. A computer-implemented method of controlling a wearable audio device configured to provide an audio output, the method comprising:
receiving data indicating the wearable audio device is proximate a geographic location associated with a localized audio message;
inserting audio content associated with a brand into an identified portion of the localized audio message; and
initiating playback of the localized audio message including the inserted audio content associated with the brand at the wearable audio device.

2. The computer-implemented method of claim 1, wherein the inserted audio content associated with the brand is selected based upon a user of the wearable audio device.

3. The computer-implemented method of claim 2, wherein the inserted audio content associated with the brand is selected based upon a predefined preference of the user of the wearable audio device.

4. The computer-implemented method of claim 2, wherein the inserted audio content associated with the brand is selected based upon a facing direction of the user of the wearable audio device.

5. The computer-implemented method of claim 1, the method further comprising:
receiving data indicating feedback from the user in response to the playback of the localized audio message.

6. The computer-implemented method of claim 1, wherein the feedback data represents a gesture from the user.

7. The computer-implemented method of claim 1, wherein the feedback data represents an interaction of the user and a smart device.

8. The computer-implemented method of claim 1, the method further comprising:
initiating the presentation of additional information to the user in response to the received feedback data.

9. The computer-implemented method of claim 6, wherein the additional information includes additional audio content associated with the brand.

10. The computer-implemented method of claim 6, wherein the additional information includes imagery associated with the brand for presenting by a smart device.

11. A computing device comprising:
memory; and
one or more processing devices configured to:
receive data indicating the wearable audio device is proximate a geographic location associated with a localized audio message;
insert audio content associated with a brand into an identified portion of the localized audio message; and
initiate playback of the localized audio message including the inserted audio content associated with the brand at the wearable audio device.

12. The device of claim 11, wherein the inserted audio content associated with the brand is selected based upon a user of the wearable audio device.

13. The device of claim 12, wherein the inserted audio content associated with the brand is selected based upon a predefined preference of the user of the wearable audio device.

14. The device of claim 12, wherein the inserted audio content associated with the brand is selected based upon a facing direction of the user of the wearable audio device.

15. The device of claim 11, further configured to:
receive data indicating feedback from the user in response to the playback of the localized audio message.

16. The device of claim 11, wherein the feedback data represents a gesture from the user.

17. The device of claim 11, wherein the feedback data represents an interaction of the user and a smart device.

18. The device of claim 1, further configured to:
initiate the presentation of additional information to the user in response to the received feedback data.

19. The device of claim 18, wherein the additional information includes additional audio content associated with the brand.

20. The device of claim 18, wherein the additional information includes imagery associated with the brand for presenting by a smart device.
